(19) United States
(12) Patent Application Publication
(10) Pub. No.: US 2010/0082834 A1
(43) Pub. Date: Apr. 1, 2010

(54) APPARATUS AND METHOD FOR TRANSMITTING AND RECEIVING DATA IN A WIRELESS COMMUNICATION NETWORK

(75) Inventors: Do-Young JOUNG, Seoul (KR); Tae-Sung PARK, Yongin-si (KR); Jae-Hoon KWON, Seongnam-si (KR); Jae-Sung PARK, Gunpo-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/571,551

(22) Filed: Oct. 1, 2009

(30) Foreign Application Priority Data
Oct. 1, 2008 (KR) 10-2008-0096632

(51) Int. Cl. G06F 15/16

(52) U.S. Cl. 709/231; 709/234

(57) ABSTRACT

An apparatus and method for transmitting and receiving data in a wireless communication network are provided, in which a terminal includes a transmitter for determining a video rate using at least one of collected radio channel information and a streaming parameter received from a corresponding terminal, converting video data included in multimedia data to video streaming data using the determined video rate, and transmitting streaming data including the video streaming data, and a receiver for receiving a streaming parameter as a feedback for the transmitted streaming data from the corresponding terminal.

### CROSS-REFERENCE TO RELATED PATENT APPLICATION

This application claims the benefit of a Korean Patent Application filed in the Korean Intellectual Property Office on Oct. 1, 2008, and assigned Serial No. 10-2008-0096632, the entire disclosure of which is hereby incorporated by reference.

### BACKGROUND OF THE INVENTION

1. Field of the Invention

Exemplary embodiments of the present invention generally relate to an apparatus and method for transmitting and receiving data in a wireless communication network. More particularly, exemplary embodiments of the present invention relate to an apparatus and method for transmitting and receiving data, which adjust a video rate taking into account a wireless communication environment.

2. Description of the Related Art

Unlike a wired communication network, a wireless communication network typically has limited available resources. Therefore, developing an efficient resource utilization scheme to optimize data transmission and reception is a major challenging task for wireless communication networks.

As wireless communication networks provide more and more data along with the development of the communication industry, the efficient resource use has emerged as a more significant issue.

Therefore, a consideration to a radio channel environment in which data is transmitted and received is a requisite for efficient resource allocation in the wireless communication network. To be more specific, resources are allocated such that data may be transmitted at a high data rate on a radio channel in good state and at a low data rate on a radio channel in poor state.

Accordingly, there exists a pressing need for developing a scheme for controlling a data rate through adjustment of resources for data transmission and reception, taking into account a fast varying radio channel environment.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a system and method for transmitting and receiving data, which efficiently control a video rate according to a wireless communication environment.

In accordance with an aspect of exemplary embodiments of the present invention, there is provided a terminal for transmitting and receiving data over a wireless communication network, in which a transmitter determines a video rate using at least one of collected radio channel information and a streaming parameter received from a corresponding terminal, converts video data included in multimedia data to video streaming data using the determined video rate, and transmits streaming data including the video streaming data, and a receiver receives a streaming parameter as a feedback for the transmitted streaming data from the corresponding terminal.

In accordance with another aspect of exemplary embodiments of the present invention, there is provided a method for transmitting and receiving data to and from a second terminal in a first terminal over a wireless communication network, in which a video rate is determined using at least one of collected radio channel information and a streaming parameter received from the second terminal, video data included in multimedia data is converted to video streaming data using the determined video rate, and streaming data including the video streaming data is transmitted.

In accordance with another aspect of the invention, there is provided a first terminal for transmitting and receiving data over a wireless communication network, including: a transmitter which determines a video rate using at least one of radio channel information and a streaming parameter received from a corresponding second terminal, converts video data included in multimedia data to video streaming data using the determined video rate, and transmits streaming data including the video streaming data; and a receiver which receives a streaming parameter relating to the transmitted streaming data, from the corresponding second terminal.

In accordance with yet another aspect of the invention, there is provided a method for transmitting and receiving data between a first terminal and a second terminal over a wireless communication network, the method including: determining a video rate using at least one of radio channel information and a streaming parameter received from the second terminal; converting video data included in multimedia data to video streaming data using the determined video rate; and transmitting streaming data including the video streaming data.

In accordance with another aspect of the invention, there is provided a method for exchanging data between a first terminal and a second terminal, the method including: adaptively determining by the first terminal, a video rate based on channel information and streaming parameter received from the second terminal; encoding video data based on the adaptively determined video rate; and transmitting the encoded video data in a current stream.

### BRIEF DESCRIPTION OF THE DRAWINGS

The above and other objects and features of certain exemplary embodiments of the present invention will be more apparent from the following detailed description taken in conjunction with the accompanying drawings, in which:

FIG. 1 is a block diagram of a conventional system for transmitting and receiving data at a variable video coding rate in compliance with a 3^{rd} Generation Partnership Project (3GPP) or 3GPP2 standard;

FIG. 2 is a block diagram of a data transmission and reception system according to an exemplary embodiment of the present invention;

FIG. 3 is a block diagram of a first terminal and a second terminal in the data transmission and reception system according to an exemplary embodiment of the present invention;

FIG. 4 is a flowchart illustrating a data transmission and reception method in the data transmission and reception system according to an exemplary embodiment of the present invention; and

FIG. 5 is a flowchart illustrating a data transmission and reception method in the data transmission and reception system according to another exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Further, the phrase “at least one of,” when preceding a list of elements, modifies the entire list of elements and does not modify each element of the list.

International standards including 3^{rd} Generation Partnership Project (3GPP), 3GPP2, etc., regulate under the titles of Multimedia Telephony for IMS (IP Multimedia Subsystem) (MTSI) and Packet Switched Video Telephony (PSVT) that a data rate is adaptively applied to data transmission and reception by sensing an end-to-end channel environment. A terminal that receives video data feeds back information collected in an application layer in a Real-Time Control Protocol Application (RTCP APP) packet to a transmitting terminal. Upon receipt of the feedback signal, the transmitting terminal determines an end-to-end channel environment based on the feedback information and determines a transmission video rate, that is, a coding rate for transmission data.

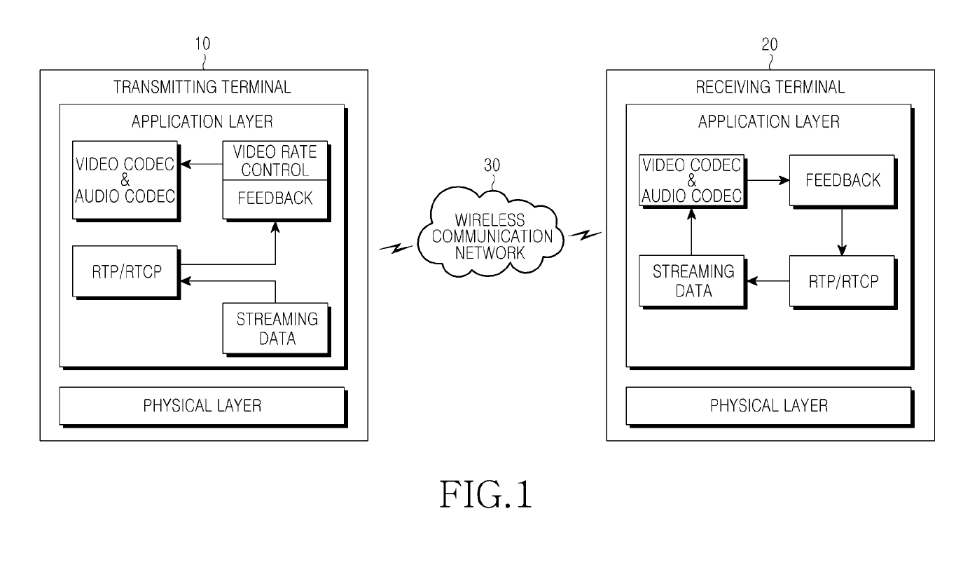

FIG. 1 is a block diagram of a conventional system for transmitting and receiving data at a variable video coding rate in compliance with a 3GPP or 3GPP2 standard.

Referring to FIG. 1, a transmitting terminal 10 and a receiving terminal 20 communicate with each other through a wireless communication network 30 and transmit and receive streaming data over the wireless communication network 30.

The transmitting terminal 10 converts video data included in multimedia data to video streaming data at a predetermined video rate using a video CODEC and transmits streaming data including the video streaming data, for example, in the form of a packet to the receiving terminal 20. The receiving terminal 20 receives the packet from the transmitting terminal 10 over the wireless communication network 30 and feeds back information collected in an application layer during the packet reception, for example, parameters related to a communication environment to the transmitting terminal 10. The transmitting terminal 10 controls the video rate using the received feedback information.

The receiving terminal 20 may notify the transmitting terminal 10 of its communication environment by a feedback message and request control of a video rate to the transmitting terminal 10. The feedback message is an RTCP APP packet an arrival-to-play out offset, an average received rate, a Next Sequence Number (NSN), a Next Unit Number (NUN), a Free Buffer Space (FBS), etc. as the communication environment-related parameters to the transmitting terminal 10. The arrival-to-play out offset is the difference between the arrival time and predicted play-out time of a Real-time Transport Protocol (RTP) media packet, expressed in units of ms.

In an example using the parameters, let the arrival time of packet i at the receiving terminal 20 be denoted by Ai, the predicted play-out time of packet i be denoted by Pi, and an offset between Ai and Pi, namely, an arrival-to-play out offset be denoted by Di. Then Di=Ai−Pi. If Di is negative-signed (−), this implies that the RTP packet is received earlier than the predicted play-out time. On the contrary, if DI is positive-signed (+), this means that the RTP packet is received later than the predicted play-out time. The receiving terminal 20 transmits the value of Di to the transmitting terminal 10. The transmitting terminal 10 increases or decreases the video rate based on the Di value so as to keep the play-out time of the receiving terminal 20.

That is, as in the above example, the receiving terminal 20 collects information about received data and transmits the collected information to the transmitting terminal 20, so that the transmitting terminal 10 estimates the congestion of a transmission path, a congestion-incurred change in the play out time of the receiving terminal 20, and a resulting predictable video rate.

However, utilization of additional parameters and addition of a parameter collection path as well as the above-described parameters may lead to determination of a more accurate and optimized video rate, compared to the conventional method.

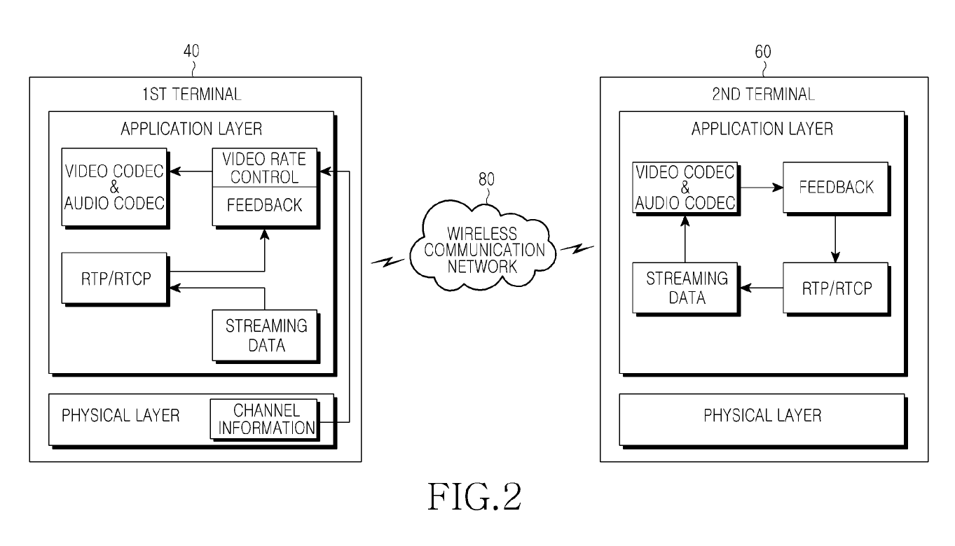

FIG. 2 is a block diagram of a data transmission and reception system according to an exemplary embodiment of the present invention.

Referring to FIG. 2, a first terminal 40 being a transmitting terminal communicates with a second terminal 60 serving as a receiving terminal through a wireless communication network 80. The first terminal 40 converts multimedia data to streaming data using a video CODEC and an audio CODEC and transmits the streaming data to the second terminal 60 by RTP. The first terminal 40 also receives a feedback for the transmitted streaming data from the second terminal 60 by RTP or RTCP. The first terminal 40 controls a video rate based on the feedback from the second terminal 60 and radio channel information provided by a physical layer.

Hereinbelow, the term ‘multimedia data’ means data before coding in the first terminal 40, i.e., uncompressed data. A coded version of the multimedia data, that is, compressed data is referred to as ‘streaming data’.

The second terminal 60 receives the streaming data from the first terminal 40 by RTP. The second terminal 60 decodes the streaming data using a video CODEC and an audio CODEC. Also, the second terminal 60 generates a feedback message and transmits it to the first terminal 40 by RTP or RTCP. In this manner, the second terminal 60 transmits feedback information for the streaming data received from the first terminal 40. The set of operations are performed in the application layer of the second terminal 60 and the feedback message is delivered to and analyzed in the application layer of the first terminal 40. Preferably, but not necessarily, a feedback channel carrying the feedback message may be one of an RTCP APP and an RTP Header Extension. The second terminal 60 may be responsible for choosing the feedback channel for transmission of the feedback message.

The first terminal 40, which generates streaming data and transmits it to the second terminal 60, may find out information about a communication environment in which the streaming data is transmitted to the second terminal 60, namely the quality of a communication channel from the feedback message received from the second terminal 60. Also, the first terminal 40 may acquire, analyze, and refer to radio channel information about the physical layer or Medium Access Control (MAC) layer of the first terminal 40 in deciding the video rate for the second terminal 60.

As stated above, the quality of a communication environment is considered from the perspective of the physical layer or the MAC layer as well as the application layer. In this context, the first terminal 40 may control the video rate, taking into account all parameters required to measure a communication quality in the physical or MAC layer as well as parameters required to measure a communication quality in the application layer. Furthermore, since the second terminal 60 receives streaming data that was transmitted in consideration of the communication quality in the application layer and the physical or MAC layer by the first terminal 40, the streaming data reception is more efficient without data loss.

In an exemplary embodiment of the present invention, it is assumed that the transmitting and receiving terminals, that is, the first and second terminals 40 and 60 are mobile communication terminals. However, the transmitting or receiving terminal according to the present invention may be any terminal capable of encoding or decoding audio or video data and conducting wireless communication over the wireless communication network 80.

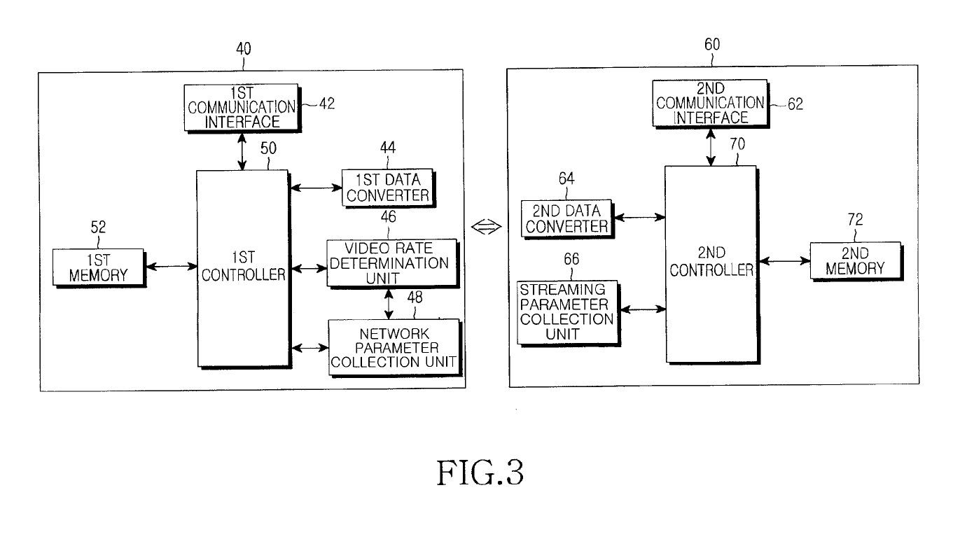

FIG. 3 is a block diagram of the first terminal and the second terminal in the data transmission and reception system according to an exemplary embodiment of the present invention.

Referring to FIG. 3, the first terminal 40 encodes video data to be transmitted to the second terminal 60 being a receiver at a video rate suitable for a communication environment in an exemplary embodiment of the present invention. The first terminal 40 transmits the coded data in the form of a packet to the second terminal 60 over the wireless communication network 80. The second terminal 60 decodes the received data and displays the decoded data. In the exemplary embodiment of the present invention, it is assumed that the first and second terminals 40 and 60 communicate in a packet-switched scheme such as Code Division Multiple Access (CDMA), Wideband Code Division Multiple Access (WCDMA), Wireless Broadband (WiBro), or the like.

In the exemplary embodiment of the present invention, the first terminal 40 includes a first communication interface 42, a first data converter 44, a video rate determination unit 46, and a network parameter collection unit 48. The first terminal 40 may further include a first memory 52 and a first controller 50.

The first communication interface 42 carries out wired and wireless communication functions of the first terminal 40. Preferably, the first communication interface 42 may include a Radio Frequency (RF) transmitter (not shown) for upconverting the frequency of a transmission signal and amplifying the upconverted signal, and an RF receiver (not shown) for low-noise-amplifying a received signal and downconverting the frequency of the low-noise-amplified signal.

In the exemplary embodiment of the present invention, the first communication interface 42 communicates wirelessly with the second terminal 60 over the wireless communication network 80. The first communication interface 42 transmits streaming data generated from the first data converter 44 to the second terminal 60 and receives data from the second terminal 60.

The first data converter 44 encodes data, i.e., multimedia data to be transmitted to the second terminal 60 in accordance with an appropriate communication format. The first data converter 44 encodes the multimedia data at a video rate pre-stored in the first memory 52 or a video rate decided by the video rate determination unit 46, as described later.

The first data converter 44 may convert video data included in uncompressed multimedia data to compressed streaming data of, for example, a data rate of 64 kbps or 128 kbps.

The network parameter collection unit 48 collects network parameters. The network parameters represent the communication environment between the first and second terminals 40 and 60. They may be used for determining a video rate in the video rate determination unit 46. The video rate determination unit 46 may collect network parameters at every predetermined interval stored in the first memory 52 or each time a feedback message is received from the second terminal 60. The network parameter collection unit 48 provides the collected network parameters to the video rate determination unit 46, for use in determining a video rate. The network parameters include radio channel information of the MAC layer or the physical layer.

In accordance with the exemplary embodiment of the present invention, the network parameters may vary with the communication scheme of the first terminal 40. For example, when the first terminal 40 operates in CDMA or WCDMA, the network parameters may include an Energy per chip over Interference noise (EcIo), a Received Signal Strength Indicator (RSSI), a Received Signal Code Power (RSCP), and a Signal-to-Interference Ratio (SIR). In case of WiBro, the network parameters may include a Modulation and Coding Scheme (MCS) level, an RSSI, and a Carrier-to-Interference and Noise Ratio (CINR).

The video rate determination unit 46 determines a video rate required for data transmission from the first terminal 40 to the second terminal 60. The video rate determination unit 46 may decide on the video rate using the network parameters collected by the network parameter collection unit 48. Also, the video rate determination unit 46 may determine the video rate using streaming parameters fed back from the second terminal 60. In another exemplary embodiment of the present invention, the video rate determination unit 46 may determine a video rate using the network parameters collected by the network parameter collection unit 48 as well as the feedback streaming parameters.

The video rate determination unit 46 may increase the video rate under the control of the first controller 50 if the communication environment is good and decrease it under the control of the first controller 50 if the communication environment is poor, which will be described later. The video rate determination unit 46 may also keep the current video rate under the control of the first controller 50.

The first memory 52 may include a program memory and a data memory. The first memory 52 stores a variety of pieces of information needed for controlling the operations of the first terminal 40. In accordance with the exemplary embodiment of the present invention, the first memory 56 may store multimedia data, a video rate, etc.

The first controller 50 provides overall control to the operations of the first terminal 40. In accordance with the exemplary embodiment of the present invention, the first controller 50 may control the video rate determination unit 46 to increase a video rate, if the communication environment between the first terminal 40 and the second terminal 60 gets better. If the communication environment gets poor, the first controller 50 may control the video rate determination unit 46 to decrease the video rate.

The second terminal 60 includes a second communication interface 62, a second data converter 64, and a streaming parameter collection unit 66. The second terminal 60 may further include a second memory 72 and a second controller 70.

The second communication interface 62 performs wired and wireless communication functions of the second terminal 60. The second communication interface 62 communicates wirelessly with the first terminal 40 over the wireless communication network 80. The second communication interface 62 receives streaming data from the first terminal 40. The streaming data is data encoded by the first data converter 44 of the first terminal 40 and may take the form of a packet.

In accordance with the exemplary embodiment of the present invention, the second communication interface 62 transmits a feedback message to the first terminal 40 by RTP/RTCP. The feedback message is used to notify that video data transmission from the first terminal 40 to the second terminal 60 is successful or data reception at the second terminal 60 failed due to a poor communication state.

The second data converter 64 decodes the data received from the first terminal 40 to a form that may be displayed in the second terminal 60. The second data converter 64 may decode compressed streaming data to uncompressed multimedia data using a video rate pre-stored in the second memory 72, as described later.

The streaming parameter collection unit 66 collects streaming parameters. The streaming parameter collection unit 66 collects parameters associated with a communication channel between the first and second terminals 40 and 60, that is, streaming parameters, so that the first or second terminal 40 or 60 may determine a video rate. In the exemplary embodiment of the present invention, the streaming parameters are limited to parameters that may be handled in an application layer. Hence the streaming parameters collected by the streaming parameter collection unit 66 include an arrival-to-play out offset, an average received rate, an NSN, an NUN, an FBS, an Audio/Video (AV) time difference, a packet loss rate, a received Frames Per Second (FPS) count, etc.

The AV time difference is the timestamp difference between an audio packet and a video packet that are included in the received streaming data. The AV time difference may be expressed in units of ms. The streaming data includes audio data and video data which may be transmitted to the second terminal 60 in an audio packet and a video packet, respectively. For the Av time difference, it may be said that AV time difference=audio timestamp-video timestamp.

The packet loss rate is the rate of packets lost during transmission of streaming data from the first terminal 40 to the second terminal 60. In general, the packet loss rate is a major index indicating a radio channel state. The received FPS count is the rate of frames received in the second terminal 60, particularly the rate of frames received the second terminal 60 with respect to frames transmitted by the first terminal 40.

The streaming parameters collected by the streaming parameter collection unit 66 are transmitted to the first terminal 40 through the second communication interface 62.

The first terminal 40 may check the state of the communication channel between the first terminal 40 and the second terminal 60 by analyzing the streaming parameters received from the second terminal 60 as well as the network parameters collected by the network parameter collection unit 48, and control the video rate of streaming data to be transmitted to the second terminal 60 according to the communication channel state.

In accordance with the exemplary embodiment of the present invention, the streaming parameter collection unit 66 may generate a feedback message under the control of the second controller 70 as described later. The feedback message is transmitted to the first terminal 40 through the second communication interface 62. The first terminal 40 determines an appropriate video rate suitable for the communication environment by analyzing the streaming parameters included in the feedback message.

Like the first memory 52 of the first terminal 40, the second memory 72 may include a program memory and a data memory. The second memory 72 stores a variety of pieces of information needed for controlling the operations of the second terminal 60. In accordance with the exemplary embodiment of the present invention, the second memory 72 may store a video rate and streaming data received from the first terminal 40, etc.

The second controller 70 provides overall control to the operations of the second terminal 60. In accordance with the exemplary embodiment of the present invention, the second controller 70 may control the streaming parameter collection unit 66 to collect streaming parameters from streaming data received from the first terminal 40.

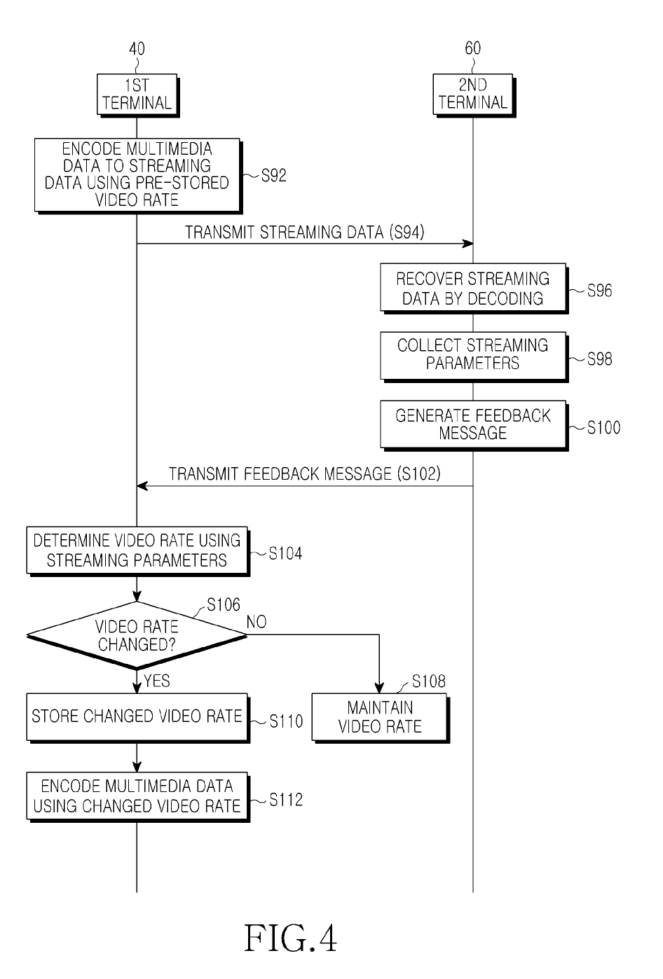

FIG. 4 is a flowchart illustrating a data transmission and reception method in the data transmission and reception system according to an exemplary embodiment of the present invention.

In the exemplary embodiment of the present invention, while only the first and second terminals 40 and 60 are illustrated, it is assumed that they communicate with each other through the wireless communication network 80.

Referring to FIG. 4, the first terminal 40 encodes video data included in multimedia data to video streaming data at a video rate pre-stored in the first memory 52, separately from audio streaming data in step S92 and transmits streaming data including the video streaming data to the second terminal 60 in step S94. The second terminal 60 recovers the received streaming data by decoding in step S96.

When the second terminal 60 receives streaming data from the first terminal, it may notify the first terminal 40 of its communication environment by collecting streaming parameters at every predetermined interval or upon generation of a predetermined event and transmitting them to the first terminal 40. The second terminal 60 collects streaming parameters in step S98 and generates a feedback message including the streaming parameters in step S100.

The streaming parameters collected by the streaming parameter collection unit 66 includes an arrival-to-play out offset, an average received rate, an NSN, an NUN, an FBS, an AV time difference, a packet loss rate, a received FPS count, etc.

In step S102, the second terminal 60 transmits the feedback message to the first terminal 40. The first terminal 40 determines a video rate based on the streaming parameters included in the received feedback message in step S104. The first controller 50 determines whether the video rate has been changed by comparing the determined video rate with the video rate pre-stored in the first memory 52 in step S106.

If the video rate has been changed in step S106, the first terminal 40 stores the changed video rate in the first memory 52 in step S110. The first controller 50 may delete the pre-stored video rate and instead, store the new video rate determined in step S104 in the first memory 52. Then the first terminal 40 encodes video data using the new video rate in step S112 and transmits the coded video data to the second terminal 60.

On the other hand, if the video rate has not been changed in step S106, the first controller 50 may not perform any particular operation in order to maintain the pre-stored video rate in step S108.

While it has been described that the second terminal 60 collects streaming parameters each time it receives streaming data from the first terminal 40 in the exemplary embodiment of the present invention, the period of collecting streaming parameters can be changed readily by those skilled in the art. In another exemplary embodiment of the present invention, the second terminal 60 may collect streaming parameters at every predetermined interval (a value pre-stored in the second memory 72). Also, the second terminal 60 may generate a feedback message at every predetermined interval (the pre-stored value) and transmit it to the first terminal 40.

In another exemplary embodiment of the present invention, the second controller 70 may control the second terminal 60 to compare a collected streaming parameter with a streaming parameter pre-stored in the second memory 72 and to generate a feedback message if the difference between the collected streaming parameter and the pre-stored streaming parameter is equal to or larger than a value pre-stored in the second memory 72. For example, if an average received rate difference is equal to or larger than 10%, the second controller 70 may control the streaming parameter collection unit 66 to generate a feedback message.

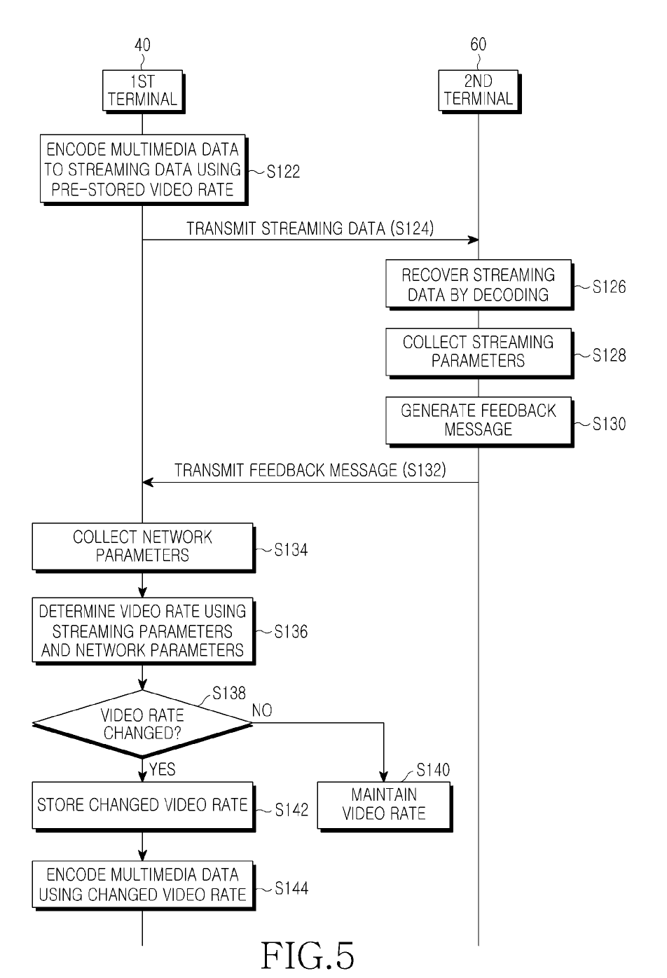

FIG. 5 is a flowchart illustrating a data transmission and reception method in the data transmission and reception system according to another exemplary embodiment of the present invention.

In the exemplary embodiment of the present invention, while only the first and second terminals 40 and 60 are illustrated, it is assumed that they communicate with each other through the wireless communication network 80.

Referring to FIG. 5, the first terminal 40 encodes video data included in multimedia data to video streaming data at a video rate pre-stored in the first memory 52, separately from audio streaming data in step S122 and transmits streaming data including the video streaming data to the second terminal 60 in step S124. The second terminal 60 recovers the received streaming data by decoding in step S126.

When the second terminal 60 receives streaming data from the first terminal 40, it may notify the first terminal 40 of its communication environment by collecting streaming parameters at every predetermined interval or upon generation of a predetermined event and transmitting them to the first terminal 40. The second terminal 60 collects streaming parameters in step S128 and generates a feedback message including the streaming parameters in step S130.

The streaming parameters collected by the streaming parameter collection unit 66 include an arrival-to-play out offset, an average received rate, an NSN, an NUN, an FBS, an AV time difference, a packet loss rate, a received FPS count, etc.

In step S132, the second terminal 60 transmits the feedback message to the first terminal 40. The network parameter collection unit 48 of the first terminal 40 collects network parameters in step S134. The network parameters include, for example, an EcIo, an RSSI, an RSCP, an SIR, etc. in CDMA or WCDMA, and an MCS level, an RSSI, a CINR, etc. in WiBro.

While the first terminal 40 collects network parameters after receiving a feedback message from the second terminal 60 in the exemplary embodiment of the present invention, the period of collecting network parameters may be readily changed by those skilled in the art. The first terminal 40 may collect network parameters at every predetermined interval (a value pre-stored in the first memory 52) irrespective of reception of a feedback message and store the network parameters in the first memory 52.

In step S136, the first terminal 40 determines a video rate based on the streaming parameters received in step S132 and the network parameters collected in step S134. The first controller 50 determines whether the video rate has been changed by comparing the determined video rate with the video rate pre-stored in the first memory 52 in step S138.

If the video rate has been changed in step S138, the first terminal 40 stores the changed video rate in the first memory 52 in step S142. The first controller 50 may delete the pre-stored video rate and instead, store the new video rate determined in step S136 in the first memory 52. Then the first terminal 40 encodes video data using the new video rate in step S144 and transmits the coded video data to the second terminal 60.

On the other hand, if the video rate has not been changed in step S138, the first controller 50 may not perform any particular operation in order to maintain the pre-stored video rate in step S140. Then the first data converter 44 of the first terminal 40 encodes video data using the pre-stored video rate.

While it has been described that the first terminal 40 determines a video rate based on streaming parameters and network parameters in the exemplary embodiment of the present invention, it may be contemplated as a further exemplary embodiment of the present invention that the first terminal 40 collects network parameters at every predetermined interval (a value pre-stored in the first memory 52) or each time it receives a feedback message from the second terminal 60 and change a video rate only based on the network parameters.

As is apparent from the above description, the exemplary embodiments of the present invention provide a system and method for transmitting and receiving data, which control a video rate according to a communication environment.

In accordance with the exemplary embodiments of the present invention, since a transmitting terminal efficiently controls a video rate, a communication environment can be optimized so that a receiving terminal can receive streaming data encoded at a video rate suitable for the communication environment and thus the streaming data can be seamlessly displayed to a user of the receiving terminal.

In accordance with the exemplary embodiments of the present invention, a video rate is determined, taking into account the communication environments of both the transmitting and receiving terminal. Therefore, overload is reduced and a channel bandwidth required for data transmission and reception can be managed efficiently.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A first terminal for transmitting and receiving data over a wireless communication network, comprising:
a transmitter which determines a video rate using at least one of radio channel information and a streaming parameter received from a corresponding second terminal, converts video data included in multimedia data to video streaming data using the determined video rate, and transmits streaming data including the video streaming data; and
a receiver which receives a streaming parameter relating to the transmitted streaming data, from the corresponding second terminal.

2. The first terminal of claim 1, wherein the receiver receives the streaming parameter from the corresponding second terminal when the corresponding second terminal receives the streaming data including the video streaming data.

3. The first terminal of claim 2, wherein the streaming parameter is at least one of an arrival-to-play out offset, an average received rate, a Next Sequence Number (NSN), a Next Unit Number (NUN), a Free Buffer Space (FBS), an Audio/Video (AV) time difference, a packet loss rate, and a received Frames Per Second (FPS) count.

4. The first terminal of claim 3, wherein the radio channel information comprises at least one of an Energy per chip over Interference noise (EcIo), a Received Signal Strength Indicator (RSSI), a Received Signal Code Power (RSCP), and a Signal-to-Interference Ratio (SIR) if the transmitter supports one of Code Division Multiple Access (CDMA) and Wideband Code Division Multiple Access (WCDMA), and the radio channel information comprises at least one of a Modulation and Coding Scheme (MCS) level, an RSSI, and a Carrier-to-Interference and Noise Ratio (CINR) if the transmitter supports Wireless Broadband (WiBro).

5. The first terminal of claim 1, wherein the radio channel information is collected at one of a physical layer and a Medium Access Control (MAC) layer.

6. The first terminal of claim 1, wherein the transmitter comprises:
a network parameter collection unit which collects the radio channel information at one of a physical layer and a MAC layer;
a video rate determination unit which determines the video rate using the streaming parameter received from the corresponding second terminal through a communication interface of the receiver and the radio channel information collected by the network parameter collection unit; and
a data converter which generates the video streaming data by encoding the video data included in the multimedia data at the determined video rate.

7. The first terminal of claim 1, wherein the corresponding second terminal comprises:
a communication interface which receives streaming data from the first terminal; and
a streaming parameter collection unit which collects the streaming parameter from the received streaming data,
wherein communication interface receives the collected streaming parameter from the streaming parameter collection unit and transmits the collected streaming parameter to the first terminal.

8. A method for transmitting and receiving data between a first terminal and a second terminal over a wireless communication network, the method comprising:
determining a video rate using at least one of radio channel information and a streaming parameter received from the second terminal;
converting video data included in multimedia data to video streaming data using the determined video rate; and
transmitting streaming data including the video streaming data.

9. The method of claim 8, wherein if the second terminal receives streaming data from the first terminal, the second terminal collects the streaming parameter at a predetermined interval.

10. The method of claim 9, wherein the streaming parameter is at least one of an arrival-to-play out offset, an average received rate, a Next Sequence Number (NSN), a Next Unit Number (NUN), a Free Buffer Space (FBS), an Audio/Video (AV) time difference, a packet loss rate, and a received Frames Per Second (FPS) count.

11. The method of claim 10, wherein the radio channel information comprises at least one of an Energy per chip over Interference noise (EcIo), a Received Signal Strength Indicator (RSSI), a Received Signal Code Power (RSCP), and a Signal-to-Interference Ratio (SIR) if the first terminal supports one of Code Division Multiple Access (CDMA) and Wideband Code Division Multiple Access (WCDMA), and the radio channel information comprises at least one of a Modulation and Coding Scheme (MCS) level, an RSSI, and a Carrier-to-Interference and Noise Ratio (CINR) if the first terminal supports Wireless Broadband (WiBro).

12. The method of claim 8, wherein the radio channel information is collected at one of a physical layer and a Medium Access Control (MAC) layer.

13. The method of claim 8, further comprising:
comparing the determined video rate with a prior video rate used for previous video streaming conversion; and
setting the determined video rate as a new video rate for video streaming conversion, if the determined video rate is different from the prior video rate.

14. The method of claim 8, wherein the determining the video rate comprises:
collecting the radio channel information in one of a physical layer and a MAC layer; and
determining the video rate based on the collected radio channel information.

15. The method of claim 8, wherein the determining the video rate comprises:
receiving the streaming parameter from the second terminal;
collecting the radio channel information in one of a physical layer and a MAC layer; and
determining the video rate based on the received streaming parameter and the collected radio channel information.

16. A method for exchanging data between a first terminal and a second terminal, the method comprising:
adaptively determining by the first terminal, a video rate based on channel information and streaming parameter received from the second terminal;
encoding video data based on the adaptively determined video rate; and
transmitting the encoded video data in a current stream.

17. The method of claim 16, wherein the second terminal determines the streaming parameter based on a previous stream.
